(19) United States
(12) Patent Application Publication
(10) Pub. No.: US 2015/0028684 A1
(43) Pub. Date: Jan. 29, 2015

(54) MULTI-CONNECTOR SPLICE BOX FOR COUPLING A PLURALITY OF POWER CONVERTERS

(71) Applicant: Enphase Energy, Inc, Petaluma, CA (US)

(72) Inventors: Michael J. Harrison, Petaluma, CA (US); John Scott Berdner, Grass Valley, CA (US)

(21) Appl. No.: 14/339,850

(22) Filed: Jul. 24, 2014

Related U.S. Application Data
(60) Provisional application No. 61/859,480, filed on Jul. 29, 2013.

(51) Int. Cl. H01R 25/00; H01R 13/629; H02J 1/00; H01R 13/46

(52) U.S. Cl. CPC H01R 25/00; H01R 13/46; H01R 13/629; H02J 1/00
USPC 307/82; 439/540.1; 439/374

(57) ABSTRACT

Embodiments of the present invention are directed to a multi-connection splice box. In one embodiment, the multi-connection splice box comprises a first plug having a first plurality of plug pins coupled to a plurality of conductors within a cable wherein the cable couples to an AC power line, and a second plug having a second plurality of plug pins coupled to the plurality of conductors, wherein the first plug detachably couples a first microinverter to the plurality of conductors and the second plug detachably couples a second microinverter to the plurality of conductors.

### CROSS-REFERENCE TO RELATED APPLICATION

This application claims priority to U.S. Provisional Patent Application No. 61/859,480 filed on Jul. 29, 2013, which is incorporated by reference herein in its entirety.

### BACKGROUND OF THE INVENTION

1. Field of the Invention

Embodiments of the present disclosure relate generally to power conversion, and, in particular, to a multi-connector splice box for simultaneously coupling a plurality of power converters to a power line.

2. Description of the Related Art

In one type of photovoltaic energy system, a plurality of photovoltaic (PV) modules are arranged in an array, and each module is coupled to a power converter. The power converters may be coupled in parallel via a cable comprising a connection splice box for each power converter, where a connector from each power converter couples to a corresponding splice box. For each power converter connection to be made there is a corresponding cost associated with materials and labor to assemble the cable and splice boxes. The majority of that cost is due to the labor, whether manual or automated, required to assemble the splice boxes; for example, exposing wires within the cable, connecting contacts to wires within the cable, and assembling a splice box housing to enclose the connections. As a result, there is a relatively high cost per each power converter connection.

Therefore, there is a need in the art for a more cost efficient topology for coupling power converters to a power line.

### SUMMARY OF THE INVENTION

Embodiments of the present invention generally relate to a multi-connection splice box substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a photovoltaic energy system in accordance with one or more embodiments of the present invention;

FIG. 2 depicts an exploded, perspective view of a splice box and a drop connector in accordance with one or more alternative embodiments of the present invention; and

FIG. 3 depicts a plug cover in accordance with one or more alternative embodiments of the present invention.

### DETAILED DESCRIPTION

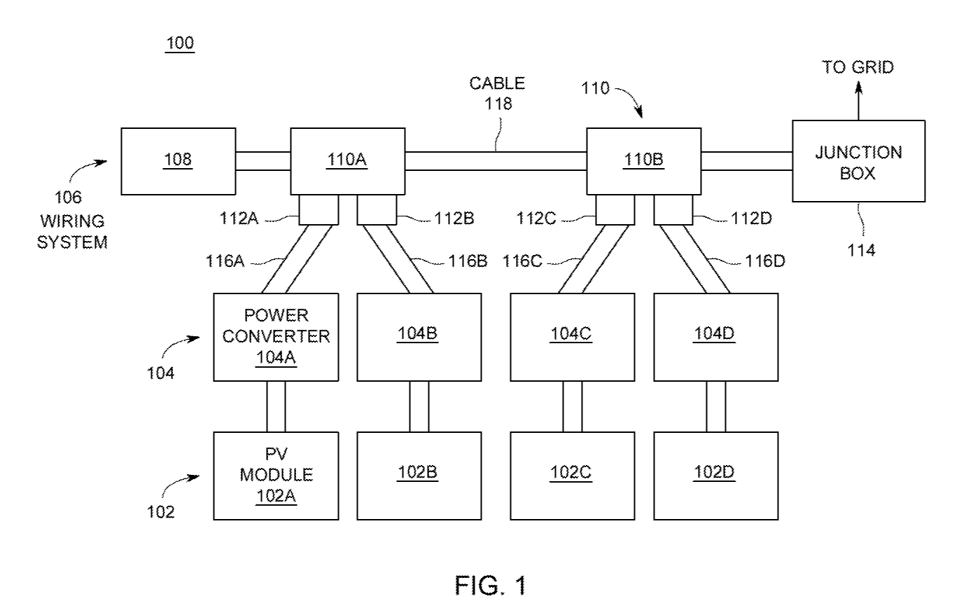

FIG. 1 depicts a block diagram of a photovoltaic energy system 100 in accordance with one or more embodiments of the present invention. The system 100 comprises a plurality of photovoltaic (PV) modules 102A, 102B, 102C and 102D (collectively referred to as PV modules 102), a plurality of power converters 104A, 104B, 104C, and 104D (collectively referred to as power converters 104), a wiring system 106, and a junction box 114. In one embodiment of the invention, each of the PV modules 102 is coupled to an individual power converter 104 as depicted in FIG. 1. In other embodiments, a PV module 102 may be coupled to a plurality of power converters 104, a plurality of PV modules 102 may be coupled to a single power converter 104, or a plurality of portions of PV modules 102 may each be coupled to a power converter 104. In some embodiments, the power converters 104 are DC-AC inverters (for example, each power converter is a microinverter coupled to a single corresponding PV module 102) and the wiring system 106 carries AC power to the junction box 114 and, ultimately, to the AC grid. In such embodiments, the DC-AC inverters may generate one, two or three phases of AC output power. In other embodiments, the power converters 104 may be DC-DC converters and the wiring system 106 may carry DC energy to a DC-AC inverter at the junction box 114 (e.g., a plurality of DC-DC boosters coupled to a centralized DC-AC inverter via a wiring system similar to the present disclosure). In general, embodiments of the invention interconnect a plurality of distributed power sources (e.g., a power converter in association with a PV module).

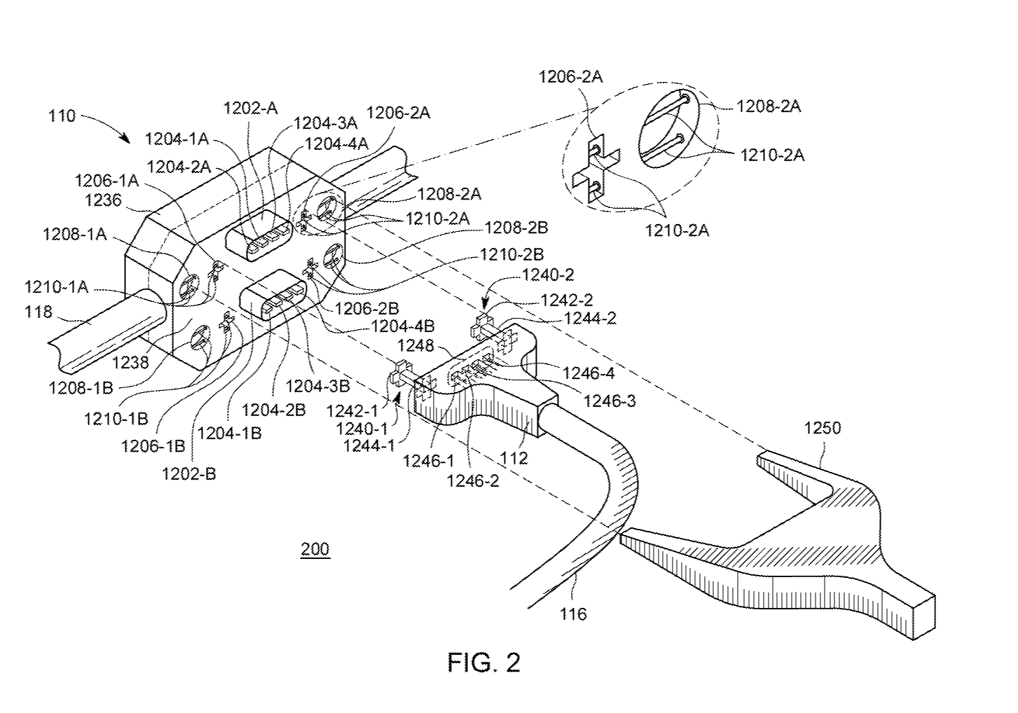

The wiring system 106 comprises a cable 118 (trunk cable), a plurality of splice boxes 110A and 110B (collectively referred to as splice boxes 110) and a termination block 108. In accordance with one or more embodiments of the present invention, each splice box 110 provides multiple connectors (described in detail with respect to FIG. 2) such that a plurality of power converters 104 may be coupled to a single splice box 110. As depicted in FIG. 1, the power converters 104A and 104B are coupled to splice box 110A via drop connector 112A/drop cable 116A and drop connector 112B/drop cable 116B, respectively, and the power converters 104C and 104D are coupled to splice box 110B via drop connector 112C/drop cable 116C and drop connector 112D/drop cable 116D, respectively. In other embodiments, each splice box 110 may provide three or more connectors for simultaneously coupling three or more power converters 104 to each splice box 110. By providing a plurality of connectors on a single splice box 110, the cost per power converter drop is significantly reduced over a configuration having one splice box connection per power converter 104.

The spacing between splice boxes 110 may be on the order of twice the width of a PV module 102 such that PV modules 102 may be vertically aligned and coupled in pairs to each of the spice boxes 110 or, alternatively, twice the PV module height such that the PV modules 102 may be horizontally aligned and coupled in pairs to each splice box 110. In some other embodiments, the splice box spacing and the PV module orientation may be such that there are more splice boxes 110 than are coupled to power converters 104. In such embodiments, the splice boxes 110 that are not coupled to inverters 104 may be coupled to caps that cover connector pins of the splice box 110.

The wiring system 106 comprises a termination block 108 at the distal end of the cable 118. The proximal end of the cable 118 is coupled to the junction box 114. The junction box 114 couples the proximal end of the cable 118 to the power grid.

The wiring system 106 can be prefabricated with the cable 118 and splice boxes 110 prior to assembly of the photovoltaic system 100 in the field. The length of the wiring system 106 can be cut before installation of the system 100 in the field or the length can be easily cut from a cable spool in the field. Once the cable 118 is cut to the length of a row of PV modules 102, the cable 118 can be physically attached to the PV module 102, attached to a strut forming a support for the PV modules 102 or laid inside a strut forming a support for the PV modules 102. In some embodiments, sequential numbering may be printed on the splice boxes 110 (i.e., one number per box) so that, once the required number of splice boxes 110 are determined, a user may easily identify the required length of the cable 118.

In one or more alternative embodiments, multiple connectors may be provided on a device other than the splice box 110 for simultaneously coupling a plurality of power converters 104 to a power line via the device. In still other alternative embodiments, the drop connectors 112/drop cable 116 (or drop cables only) may be part of the form factor of the splice boxes 110 and each comprise a connector at the power converter side for connecting to a power converter 104.

In one embodiment of the invention, the splice boxes 110 are attached to the trunk cable 118 and the assembly is rolled onto a cable spool. The splice boxes 110 are positioned along the cable 118 at intervals required for utilization with a photovoltaic module array. A conventional PV module has the dimensions of 1.0 m width and a height 1.6 m. In one embodiment, the spacing of the splice boxes 110 is on the order of 1.6 m such that when the PV modules 104 are mounted horizontally every other splice box 110 is coupled to a pair of power converters 104, and when the PV modules 102 are mounted vertically every splice box 110 is coupled to a pair of power converters 104. Thus, a single cable system format can be used in a PV system having any orientation of PV module 102. Once the PV modules 102 are mounted, the wiring system 106 need only be cut to the proper length, capped at the distal end, connected to the junction box 114 at the proximal end, and the drop connectors 112 connected to the appropriate splice boxes 110. Consequently, the speed at which a photovoltaic system can be installed is substantially enhanced.

FIG. 2 depicts an exploded, perspective view 200 of a splice box 110 and a drop connector 112 in accordance with one or more alternative embodiments of the present invention. The splice box 110 is substantially rectangular in shape (although other shapes may be used) and comprises a housing base 1236 and a housing cover 1238 that are mated around the trunk cable 118 (i.e., the trunk cable 118 “passes through” through splice box 110) to protect electrical connections within the body of the splice box 110. In some embodiments, such as the embodiment depicted in FIG. 2, the trunk cable 118 may be substantially round in shape; in other embodiments, the trunk cable 118 may be a different type of cable, such as a flat ribbon cable. The trunk cable 118 may comprise a different number of wires in different embodiments, such as three wires, four wires (e.g., to support ground, neutral, and two AC phases) or five wires (e.g., to support ground, neutral, and three AC phases), or the cable 118 may comprise two wires in an embodiment where the power converters 104 are DC-DC converters and the wiring system 106 carries DC energy.

The splice box 110 comprises a plug 1202-A projecting from the housing cover 1238 between a pair of guide pin receptacles 1206-1A and 1206-2A collectively referred to as guide pin receptacles 1206A. The guide pin receptacles 1206-1A and 1206-2A are located between a pair of release apertures 1208-1A and 1208-2A, collectively referred to as release apertures 1208A, although in other embodiments the release apertures 1208A may be between the guide pin receptacles 1206A. The plug 1202-A may be part of the form factor of the housing cover 1238, and the housing cover 1238, plug 1202-A, and housing base 1236 may be formed of injection-molded plastic.

The plug 1202-A surrounds four plug pins 1204-1A, 1204-2A, 1204-3A, and 1204-4A, collectively referred to as plug pins 1204A, although in other embodiments there may be a different number of plug pins 1204A based on the number of wires in the cable 118 or the number of output lines from a power converter 104. The plug pins 1204A extend through the housing cover 1238; in some embodiments, the plug pins 1204A may have a pitch of 8.5 mm. The plug pins 1204A are formed of a conductive material and, within the splice box 110, are coupled to wire conductors of the cable 118 in a one-to-one correspondence (although in some embodiments, some plug pins 1204 may remain uncoupled or there may be fewer plug pins 1204 than wire conductors). In some embodiments, the wire conductors may be exposed during assembly, for example using mechanical or laser stripping to remove a portion of cable and wire insulation, and each wire conductor is identified as corresponding to neutral, ground, or a specific AC phase as applicable, and is electrically coupled to an individual plug pin 1204A in a one-to-one correspondence. The wire conductors and plug pins 1204A may be electrically coupled via soldering, crimping, or a similar technique. In some other embodiments, the cable insulation may be removed and piercing connectors may be used to pierce the wire insulation to create an electrical connection between the plug pins 1204A and the wire conductors. In certain embodiments using multi-phase power, the arrangement of wire conductor connections to plug pins 1204A may be rotated by one phase at each splice box 110 and/or at each plug 1202 in each splice box 110 along the cable 118 (i.e., a phase rotation technique may be used).

In some embodiments, each plug pin 1204A extending outward from the housing base 1236 may be isolated from the other plug pins 1204A within the plug 1202-A by divider walls that are part of the plug form factor. Additionally or alternatively, one of the plug pins 1204A may extend further outward from the housing base 1236 than the remaining plug pins 1204A to enable a make-first-break-last connection.

The guide pin receptacles 1206A and release apertures 1208A are horizontally aligned with respect to the plug 1202-A, although in other embodiments different arrangements may be used. The release apertures 1208A are generally circular in shape and extend through at least a portion of the width of the splice box 110. The guide pin receptacles 1206A are of a size and shape to mate with drop connector guide pins 1240, described further below. Generally, one of the guide pin receptacles 1206A, e.g., guide pin receptacle 1206-1A, may be sized differently with respect to the remaining guide pin receptacle 1206A, e.g., guide pin receptacle 1206-2A, to facilitate proper alignment of the drop connector 112 with respect to the splice box 110; in some embodiments, such alignment may be facilitated by one of the guide pin receptacles 1206A being shaped and/or oriented differently than the other guide pin receptacle 1206A.

A pair of retention bars 1210-1A extends horizontally through the guide pin receptacle 1206-1A and the adjacent release aperture 1208-1A, and a pair of retention bars 1210-2A extend horizontally through the guide pin receptacle 1206-2A and the adjacent release aperture 1208-2A. The retention bars 1210-A retain the drop connector 112 (once connected) and are positioned such that they may be pressed apart from one another and subsequently return to their original position; for example, the retention bars 1210-A may be one or more of legs of a flexible U-shaped element disposed within the splice box 110, held in position by spring mechanisms, or any element for providing the functionality described below for retaining the drop connector 112 or the plug cover 300 as described further below. In some alternative embodiments, different mechanisms may be used for coupling the drop connector 112 to the splice box 110, retaining the drop connector 112 once coupled to the splice box 110, and/or releasing the drop connector 112 from the splice box 110. One example of a plug 1202, guide pin receptacles 1206 and release aperture 1208 may be found in commonly assigned, co-pending U.S. patent application 12/, which is herein incorporated by reference in its entirety.

The splice box 110 additionally comprises a second plug 1202-B projecting from the housing cover 1238, and the plug 1202-B surrounds plug pins 1204-1B, 1204-2B, 1204-3B, and 1204-4B, collectively referred to as plug pins 1204B. The splice box 110 further comprises a second pair of guide pin receptacles 1206-1B and 1206-2B (collectively referred to as guide pin receptacles 1206-B) and a second pair of release apertures 1208-1B and 1208-2B (collectively referred to as release apertures 1208B). A pair of retention bars 1210-1B extends horizontally through the guide pin receptacle 1206-1B and the adjacent release aperture 1208-1B, and a pair of retention bars 1210-2B extend horizontally through the guide pin receptacle 1206-2B and the adjacent release aperture 1208-2B. The plug 1202-B, plug pins 1204-B, guide pin receptacles 1206-B, release apertures 1208B, and retention bars 1210-B are analogous in both form and function to the plug 1202-A, plug pins 1204-A, guide pin receptacles 1206-A, release apertures 1208A, and retention bars 1210-A, respectively, for coupling a power converter 104 to the splice box 110. Although the plugs 1202A and 1202B are depicted as vertically aligned (i.e., one plug disposed atop the other plug), the plugs 1202A and 1202B (as well as their corresponding guide pin receptacles 1206 and retention bars 1210) may be arranged in other configurations on the splice box 110.

Although the splice box 110 comprises two plugs 1202A and 1202B, for clarity only a single drop connector 112 is depicted in the exploded, perspective view 200 of FIG. 2. The splice box 110 is capable though of simultaneously being coupled to two power converters 104 via the plugs 1202A and 1202B. The drop connector 112 comprises a socket 1248 and guide pins 1240-1 and 1240-2, collectively referred to as guide pins 1240. The guide pins 1240 are disposed on each horizontal side of the socket 1248. The guide pins 1240-1 and 1240-2 comprise shafts 1244-1 and 1244-2, respectively, which terminate in protuberances 1242-1 and 1242-2, respectively, and are of a size and shape to mate with the guide pin receptacles 1206-1A and 1206-2A, respectively (or, alternatively, guide pin receptacles 1206-1B and 1206-2B). In some embodiments, the guide pins 1240 may have a cross-shaped cross section.

The drop connector 112 further comprises plug pin receptacles 1246-1, 1246-2, 1246-3, and 1246-4, collectively referred to as plug pin receptacles 1246, disposed within the socket 1248. Within the drop connector 112, each of the plug pin receptacles 1246 is electrically coupled to a different conductive element within the drop cable 116 (e.g., ground, neutral, and two AC phase lines). In some other embodiments, the drop connector 112 may comprise two plug pin receptacles 1246 (i.e., for a DC-DC converter), three plug-pin receptacles 1246, or five plug pin receptacles 1246 for coupling to respectively, three, four or five wires within the drop cable 116 (e.g., ground, neutral, and three AC phases). The plug pin receptacles 1246 are of a size and shape to mate with the plug pins 1204A of the splice box 110 (or alternatively, the plug pins 1204B), thereby electrically coupling corresponding conductors within the trunk cable 118 and the drop cable 116.

When the drop connector 112 is coupled to the splice box 110 for example, via the plug 1202A, the guide pins 1240 are inserted into the guide pin receptacles 1206A. The retention bars 1210-A within the guide pin receptacles 1206A are forced apart as the protuberances 1242 pass between the retention bars 1210-A. The retention bars 1210-A then close around the guide pin shafts 1244, locking the drop connector 112 to the splice box 110. Additionally, the socket 1248 may snap-fit to the plug 1202-A to further secure the drop connector 112 to the splice box 110. In some embodiments, an 0-ring may be present around the plug 1202-A to provide an environmental seal between the drop connector 112 and the splice box 110.

In order to disengage the drop connector 112 from the splice box 110, an extraction tool 1250 may be used. In some embodiments, the extraction tool 1250 may be in the shape of a two-pronged fork with tapered prongs. To release the drop connector 112 from the splice box 110, the prongs are inserted into the release apertures 1208A to spread apart the retention bars 1210-A so that the guide pin protuberances 1242 may pass between the retention bars 1210A. The drop connector 112 can then be pulled away from the splice box 110. In other embodiments, the extraction tool 1250 may have a different shape but provide the same functionality for disengaging the drop connector 112 from the splice box 110.

In certain embodiments, the cable 118 may be coupled via the junction box 114 to an AC line, having a greater number of phases than the number of phases generated by each power converter 104, and a phase-rotation technique is used to produce a substantially balanced multi-phase output from the wiring system 106. For example, in some embodiments, the cable 118 may comprise fine wire conductors (ground, neutral, and three AC phases) for coupling to a three-phase power grid, and each power converter 104 generates a single-phase AC output. In some of such embodiments, the plug pins 1204A and 1204B may both be coupled to a first phase at a splice box 110, while the plug pins 1204A/1204B at the next splice box 110 are coupled to a second phase and at the following splice box 110, the plug pins 1204A/1204B are coupled to a third phase; such phase rotation is repeated at each subsequent splice box 110 along the cable 118. In some other embodiments, the phase connections may be rotated at each plug 1202 (i.e., at a particular splice box 110 the plus pins 1204A and 1204B are coupled to different phases within the cable 118) in addition to or in place of phase rotation at each splice box 110. Although the number of plug pins 1204 may be equal to the number output lines from a power converter 104, in some embodiments, there may be plug pins 1204 that are not used by the corresponding power converter 104 and thus may not be coupled to any wire conductors in the cable 118.

In some alternative embodiments, the splice box 110 comprises one or more additional plugs/plug pins, as well as corresponding guide pin receptacles and release apertures (or similar mechanisms), for coupling one or more additional inverters to the splice box 110.

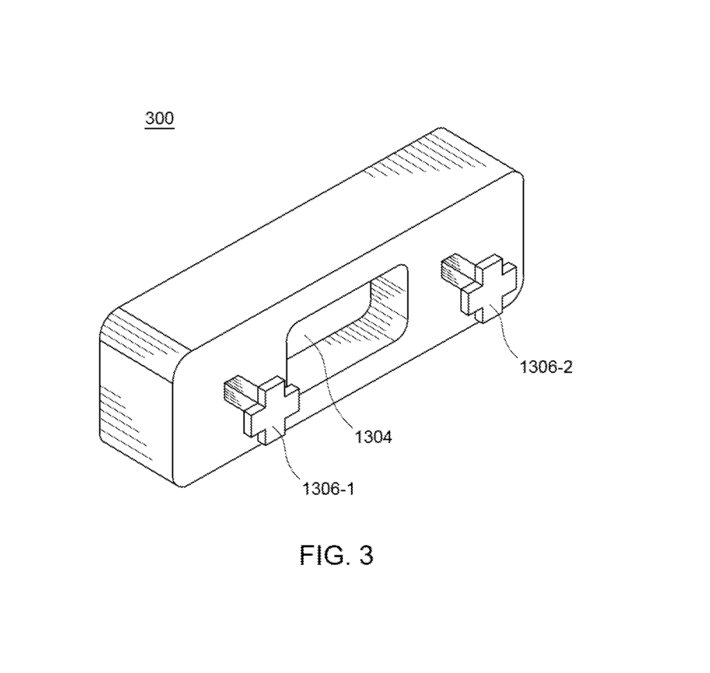

FIG. 3 depicts a plug cover 300 in accordance with one or more alternative embodiments of the present invention. The plug cover 300 comprises a plug receptacle 1304 and cover guide pins 1306-1 and 1306-2. The plug cover 300 is of a size and shape to mate with the splice box 110 and provide an environmental seal for a plug 1202-A or 1202-B. The plug cover 300 is coupled to the splice box 110 in the same manner that the drop connector 112 is coupled to the splice box 110 and is utilized to protect the plug pins 1204A or 1204B of any splice box 110 not being used and/or not coupled to a drop connector 112. The extraction tool 1250 or a similar tool may be used to disengage the plug cover 300 from the splice box 110 by inserting the extraction tool prongs into the release apertures 1208A or 1208B as necessary and pulling the plug cover 300 from the splice box 110. In some embodiments, the plug receptacle 1304 may “snap fit” tightly to the plug 1202-A or 1202-B to secure the plug cover 300 to the splice box 110. In some such embodiments, the cover guide pins 1306 may not be required and the plug cover 300 may be disengaged from the splice box 110 merely by pulling the plug cover 300 from the splice box 110.

In some embodiments, the plug cover 300 may be fabricated of injection-molded plastic.

In one or more alternative embodiments, the plug cover 300 may be suitably sized and comprise a second plug receptacle 1304 such that a single plug cover 300 may be used to cover both plugs 1202-A and 1202-B of the splice box 110.

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. A multi-connection splice box, comprising:
a first plug having a first plurality of plug pins coupled to a plurality of conductors within a cable wherein the cable couples to an AC power line; and
a second plug having a second plurality of plug pins coupled to the plurality of conductors,
wherein the first plug detachably couples a first microinverter to the plurality of conductors and the second plug detachably couples a second microinverter to the plurality of conductors.

2. The multi-connection splice box of claim 1, wherein the first plurality of plug pins are coupled to a different set of phase lines of the plurality of conductors than the second plurality of plug pins.

3. The multi-connection splice box of claim 1, wherein the first plug and the second plug project from a housing cover of the splice box respectively between a first pair of guide pin receptacles and a second pair of guide pin receptacles.

4. The multi-connection splice box of claim 3, wherein the first pair of guide pin receptacles and the second pair of guide pin receptacles are located between a first pair of release apertures and a second pair of release apertures, respectively.

5. The multi-connection splice box of claim 3, wherein one of the first plurality of plug pins and one of the second plurality of plug pins extends further outwards from a housing base than other plug pins in the first plurality of plug pins and the second plurality of plug pins, respectively, enabling a make-first-break-last connection.

6. A system for coupling power to a power grid comprising:
a plurality of microinverters; and
a cable comprising a plurality of splice boxes spaced along the cable, wherein each splice box comprises:
a first plug having a first plurality of plug pins coupled to a plurality of conductors within a cable wherein the cable couples to an AC power line; and
a second plug having a second plurality of plug pins coupled to the plurality of conductors,
wherein the first plug detachably couples to a first microinverter of the plurality of microinverters and the second plug detachably couples to second microinverters of the plurality of microinverters.

7. The system of claim 6, wherein the first plurality of plug pins are coupled to a different set of phase lines of the plurality of conductors than the second plurality of plug pins.

8. The system of claim 6, wherein the first plug and the second plug project from a housing cover of the splice box respectively between a first pair of guide pin receptacles and a second pair of guide pin receptacles.

9. The system of claim 8, wherein the first pair of guide pin receptacles and the second pair of guide pin receptacles are located between a first pair of release apertures and a second pair of release apertures, respectively.

10. The system of claim 8, wherein one of the first plurality of plug pins and one of the second plurality of plug pins extends further outwards from a housing base than other plug pins in the first plurality of plug pins and the second plurality of plug pins, respectively, enabling a make-first-break-last connection.

11. The system of claim 6, further comprising a plurality of PV modules coupled to the plurality of microinverters in a one to one correspondence.

12. The system of claim 11, wherein the plurality of splice boxes are spaced along the cable at intervals on the order of twice the width of a PV module of the plurality of PV modules.

13. The system of claim 12, wherein each of the plurality of splice boxes are spaced at intervals on the order of 1.6 meters apart.

14. The system of claim 12, wherein each splice box of the plurality of splice boxes has a sequential number on the each splice box.

15. The system of claim 6, wherein at each splice box of the plurality of splice boxes, the first plurality of plug pins are coupled to a different set of phase lines of the plurality of conductors than the second plurality of plug pins.

16. The system of claim 15, wherein connection to the phase lines of the plurality of conductors is rotated among phases at each successive splice box of the plurality of splice boxes.

17. The system of claim 16, wherein the AC power line is a three-phase power line and each microinverter generates fewer than three phases of output power.

18. The system of claim 6, wherein at each splice box of the plurality of splice boxes, the first plurality of plug pins and the second plurality of plug pins are both connected to the same set of phase lines of the plurality of conductors.

19. The system of claim 18, wherein connection to the phase lines of the plurality of conductors is rotated among phases at each successive splice box of the plurality of splice boxes.

20. The system of claim 19, wherein the AC power line is a three-phase power line and each microinverter generates fewer than three phases of output power.
